(19) United States
(12) Patent Application Publication
(10) Pub. No.: US 2025/0102765 A1
(43) Pub. Date: Mar. 27, 2025

(54) OPTICAL IMAGING LENS

(71) Applicant: GENIUS ELECTRONIC OPTICAL (XIAMEN) CO., LTD., Xiamen (CN)

(72) Inventors: Chuanbo Dong, Xiamen (CN); Meiting He, Xiamen (CN); Qida Zhao, Xiamen (CN); Hung-Chien Hsieh, Xiamen (CN)

(73) Assignee: GENIUS ELECTRONIC OPTICAL (XIAMEN) CO., LTD., Xiamen (CN)

(21) Appl. No.: 18/646,782

(22) Filed: Apr. 26, 2024

(30) Foreign Application Priority Data
Sep. 22, 2023 (CN) 202311234683.2

(51) Int. Cl. G02B 9/34; G02B 13/00

(52) U.S. Cl. CPC G02B 9/34; G02B 13/006

(57) ABSTRACT

Disclosed is an optical imaging lens including a first lens element, a second lens element, a third lens element and a fourth lens element arranged in a sequence from an object side to an image side along an optical axis. Refracting power of the second lens element is positive. An image side surface of the Nth lens element counted from the object side to the image side along the optical axis is cemented to an object side surface of the N+1th lens element counted from the object side to the image side along the optical axis, and N is a positive integer greater than or equal to 1 and less than or equal to 3. The optical imaging lens satisfies: EFL/Fno≥2.200 mm, wherein EFL is an effective focal length of the optical imaging lens, and Fno is a f-number of the optical imaging lens.

### CROSS-REFERENCE TO RELATED APPLICATION

This application claims the priority benefit of China application serial no. 202311234683.2, filed on Sep. 22, 2023. The entirety of the above-mentioned patent application is hereby incorporated by reference herein and made a part of this specification.

### BACKGROUND

### Technical Field

The disclosure relates to an optical element, and particularly an optical imaging lens.

### Description of Related Art

The specifications of portable electronic products are ever changing, and the key components thereof, namely optical imaging lenses, are also developing in more diversified ways.

The application of optical imaging lenses is not only limited to capturing images and recording videos, but also involves telephoto photography, and the optical zoom function may be achieved through the use of wide-angle lenses. The longer the effective focal length of the telephoto lens is, the higher optical zoom magnification will be. It is a challenge for practitioners in the art to explore how to provide an optical imaging lens with a long effective focal length and excellent imaging quality.

### SUMMARY

The present disclosure provides an optical imaging lens with a long effective focal length and good imaging quality.

An embodiment of the present disclosure provides an optical imaging lens, which includes a first lens element, a second lens element, a third lens element and a fourth lens element arranged in a sequence along an optical axis from an object side to an image side. Each of the first lens element to the fourth lens element includes an object-side surface facing the object side and allowing imaging rays to pass through, and an image-side surface facing the image side and allowing the imaging rays to pass through. An optical axis region of the object-side surface of the first lens element is convex. The second lens element has positive refracting power. A periphery region of the image-side surface of the third lens element is concave. A periphery region of the image-side surface of the fourth lens element is concave. The lens elements of the optical imaging lens only include the first lens element to the fourth lens element. An image-side surface of the Nth lens element counted from the object side to the image side along the optical axis is cemented to an object-side surface of the N+1th lens element counted from the object side to the image side along the optical axis, and N is a positive integer greater than or equal to 1 and less than or equal to 3. The optical imaging lens satisfies: EFL/Fno≥2.200 mm, wherein EFL is an effective focal length of the optical imaging lens, and Fno is a f-number of the optical imaging lens.

An embodiment of the present disclosure provides an optical imaging lens, which includes a first lens element, a second lens element, a third lens element and a fourth lens element arranged in a sequence along an optical axis from an object side to an image side. Each of the first lens element to the fourth lens element includes an object-side surface facing the object side and allowing imaging rays to pass through, and an image-side surface facing the image side and allowing the imaging rays to pass through. An optical axis region of the object-side surface of the first lens element is convex. The second lens element has positive refracting power. The third lens element has negative refracting power. An optical axis region of the image-side surface of the fourth lens element is concave. The lens elements of the optical imaging lens only include the first lens element to the fourth lens element. An image-side surface of the Nth lens element counted from the object side to the image side along the optical axis is cemented to an object-side surface of the N+1th lens element counted from the object side to the image side along the optical axis, and N is a positive integer greater than or equal to 1 and less than or equal to 3. The optical imaging lens satisfies: EFL/Fno≥2.200 mm, wherein EFL is an effective focal length of the optical imaging lens, and Fno is a f-number of the optical imaging lens.

An embodiment of the present disclosure provides an optical imaging lens, which includes a first lens element, a second lens element, a third lens element and a fourth lens element arranged in a sequence along an optical axis from an object side to an image side. Each of the first lens element to the fourth lens element includes an object-side surface facing the object side and allowing imaging rays to pass through, and an image-side surface facing the image side and allowing the imaging rays to pass through. The second lens element has positive refracting power. The third lens element has negative refracting power. An optical axis region of the object-side surface of the fourth lens element is convex, and an optical axis region of the image-side surface of the fourth lens element is concave. The lens elements of the optical imaging lens only include the first lens element to the fourth lens element. An image-side surface of the Nth lens element counted from the object side to the image side along the optical axis is cemented to an object-side surface of the N+1th lens element counted from the object side to the image side along the optical axis, and N is a positive integer greater than or equal to 1 and less than or equal to 3. The optical imaging lens satisfies: EFL/Fno≥2.200 mm, wherein EFL is an effective focal length of the optical imaging lens, and Fno is a f-number of the optical imaging lens.

Based on the above, the advantageous effect of the optical imaging lens according to the embodiments of the present disclosure is that by satisfying the arrangement of concave-convex shape design of the lens element, the refracting power condition and through the design that satisfies the above conditional expression, the optical imaging lens not only has a long effective focal length, but also maintains a good imaging quality.

### BRIEF DESCRIPTION OF THE DRAWINGS

FIG. 1 is a schematic view illustrating a surface structure of a lens element.

FIG. 2 is a schematic view illustrating a concave-convex surface structure of a lens element and a ray focal point.

FIG. 3 is a schematic view illustrating a surface structure of a lens element according to an Example 1.

FIG. 4 is a schematic view illustrating a surface structure of a lens element according to an Example 2.

FIG. 5 is a schematic view illustrating a surface structure of a lens element according to an Example 3.

FIG. 6 is a schematic view illustrating an imaging optical lens according to a first embodiment of the disclosure.

FIG. 7 is a schematic view illustrating an optical imaging lens according to the first embodiment of the disclosure.

FIG. 8A to FIG. 8D are schematic views showing other aberrations and a longitudinal spherical aberration of the optical imaging lens of the first embodiment.

FIG. 9 provides detailed optical data of the optical imaging lens of the first embodiment of the disclosure.

FIG. 10 provides aspherical parameters of the optical imaging lens of the first embodiment of the disclosure.

FIG. 11 is a schematic view of an optical imaging lens according to the second embodiment of the disclosure.

FIG. 12A to FIG. 12D are schematic views showing other aberrations and a longitudinal spherical aberration of the optical imaging lens of the second embodiment.

FIG. 13 provides detailed optical data of the optical imaging lens of the second embodiment of the disclosure.

FIG. 14 provides aspherical parameters of the optical imaging lens of the second embodiment of the disclosure.

FIG. 15 is a schematic view of an optical imaging lens according to the third embodiment of the disclosure.

FIG. 16A to FIG. 16D are schematic views showing other aberrations and a longitudinal spherical aberration of the optical imaging lens of the third embodiment.

FIG. 17 provides detailed optical data of the optical imaging lens of the third embodiment of the disclosure.

FIG. 18 provides aspherical parameters of the optical imaging lens of the third embodiment of the disclosure.

FIG. 19 is a schematic view of an optical imaging lens according to the fourth embodiment of the disclosure.

FIG. 20A to FIG. 20D are schematic views showing other aberrations and a longitudinal spherical aberration of the optical imaging lens of the fourth embodiment.

FIG. 21 provides detailed optical data of the optical imaging lens of the fourth embodiment of the disclosure.

FIG. 22 provides aspherical parameters of the optical imaging lens of the fourth embodiment of the disclosure.

FIG. 23 is a schematic view of an optical imaging lens according to the fifth embodiment of the disclosure.

FIG. 24A to FIG. 24D are schematic views showing other aberrations and a longitudinal spherical aberration of the optical imaging lens of the fifth embodiment.

FIG. 25 provides detailed optical data of the optical imaging lens of the fifth embodiment of the disclosure.

FIG. 26 provides aspherical parameters of the optical imaging lens of the fifth embodiment of the disclosure.

FIG. 27 is a schematic view of an optical imaging lens according to the sixth embodiment of the disclosure.

FIG. 28A to FIG. 28D are schematic views showing other aberrations and a longitudinal spherical aberration of the optical imaging lens of the sixth embodiment.

FIG. 29 provides detailed optical data of the optical imaging lens of the sixth embodiment of the disclosure.

FIG. 30 provides aspherical parameters of the optical imaging lens of the sixth embodiment of the disclosure.

FIG. 31 shows important parameters and relation values thereof pertaining to the optical imaging lens according to the first through the sixth embodiments of the disclosure.

### DESCRIPTION OF THE EMBODIMENTS

The terms “optical axis region”, “periphery region”, “concave”, and “convex” used in this specification and claims should be interpreted based on the definition listed in the specification by the principle of lexicographer.

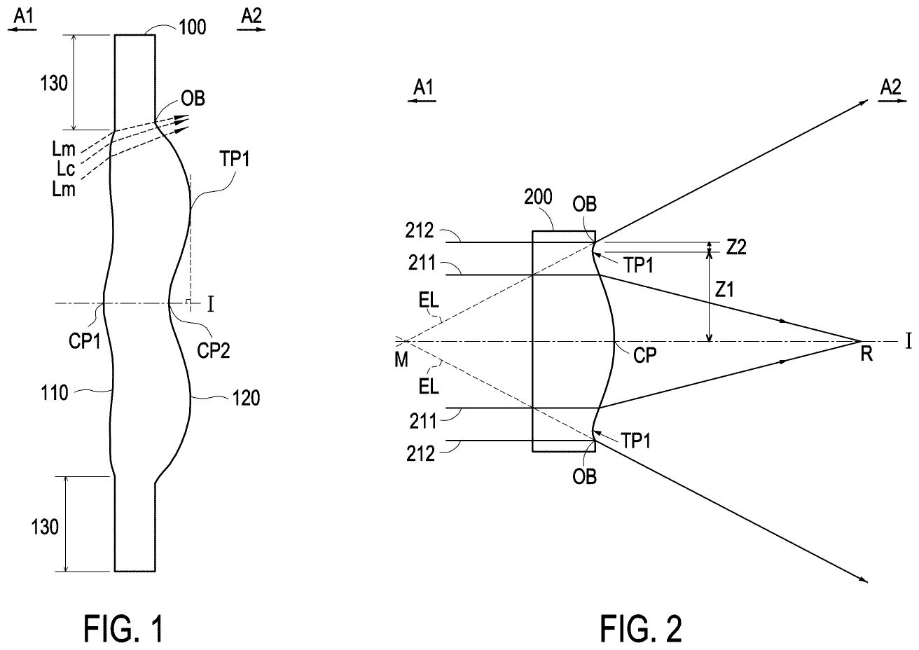

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of the lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. Moreover, a surface of the lens element 100 may have no transition point or have at least one transition point. If multiple transition points are present on a single surface, then these transition points are sequentially named along the outward radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element 100 to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted from the following drawings.

Referring to FIG. 2, an optical axis region Z1 is defined between the central point CP and the first transition point TP1. A periphery region Z2 is defined between TP1 and the optical boundary OB of the surface of the lens element. As shown in FIG. 2, a collimated ray 211 intersects the optical axis I on the image side A2 of the lens element 200 after passing through the optical axis region Z1, i.e., the focal point of the collimated ray 211 after passing through optical axis region Z1 is on the image side A2 of the lens element 200 at point R. Accordingly, since the ray itself intersects the optical axis I on the image side A2 of the lens element 200, the optical axis region Z1 is convex. On the contrary, the collimated ray 212 diverges after passing through the periphery region Z2. As shown in FIG. 2, the extension line EL of the collimated ray 212 after passing through the periphery region Z2 intersects the optical axis I on the object side A1 of the lens element 200, i.e., the focal point of the collimated ray 212 after passing through the periphery region Z2 is on the object side A1 of the lens element 200 at point M. Accordingly, since the extension line EL of the ray intersects the optical axis I on the object side A1 of the lens element 200, the periphery region Z2 is concave. In the lens element 200 illustrated in FIG. 2, the first transition point TP1 is the border of the optical axis region and the periphery region, i.e., the first transition point TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex-(concave-) region,” can be used alternatively.

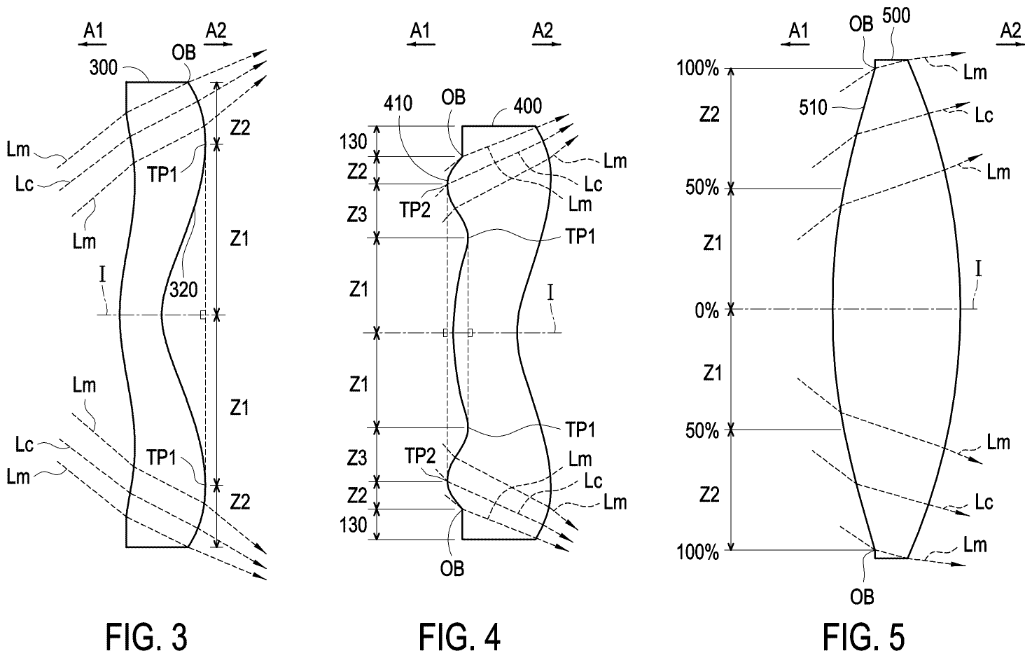

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of the lens element 300 are illustrated in FIG. 3. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1. FIG. 4 is a radial cross-sectional view of a lens element 400. Referring to FIG. 4, a first

transition point TP1 and a second transition point TP2 are present on the object-side surface 410 of the lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, an intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410 arranged in sequence along the outward radial direction from the optical axis I. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. The lens element 500 has no transition point on the object-side surface 510 of the lens element 500. For a surface of a lens element with no transition point, for example, the object-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element 500. Referring to the lens element 500 illustrated in FIG. 5, the optical axis region Z1 of the object-side surface 510 is defined between the optical axis I and 50% of the distance between the optical axis I and the optical boundary OB of the surface of the lens element 500. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that the lens element 500 may have a mounting portion (not shown) extending radially outward from the periphery region Z2.

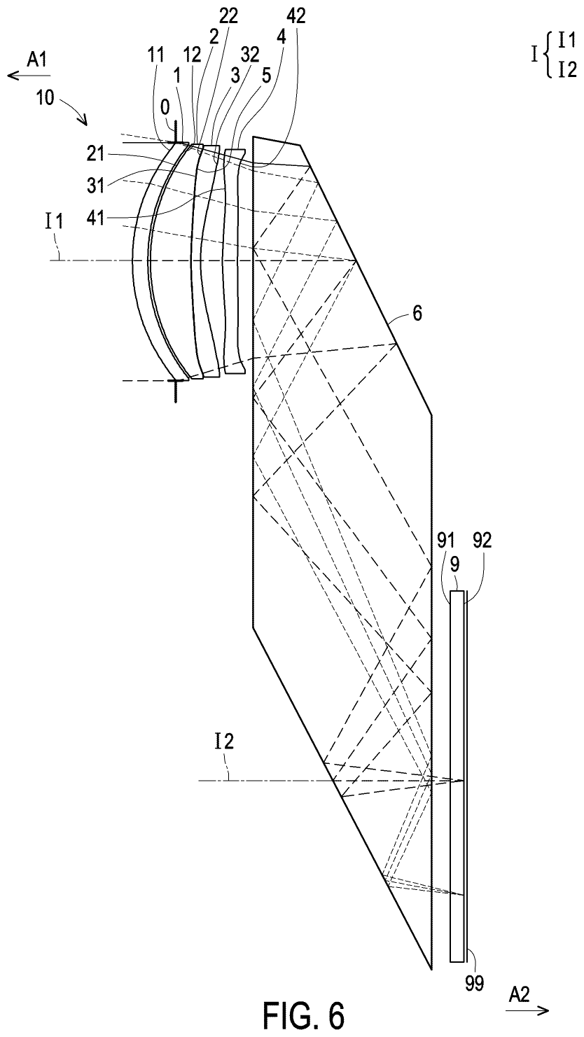

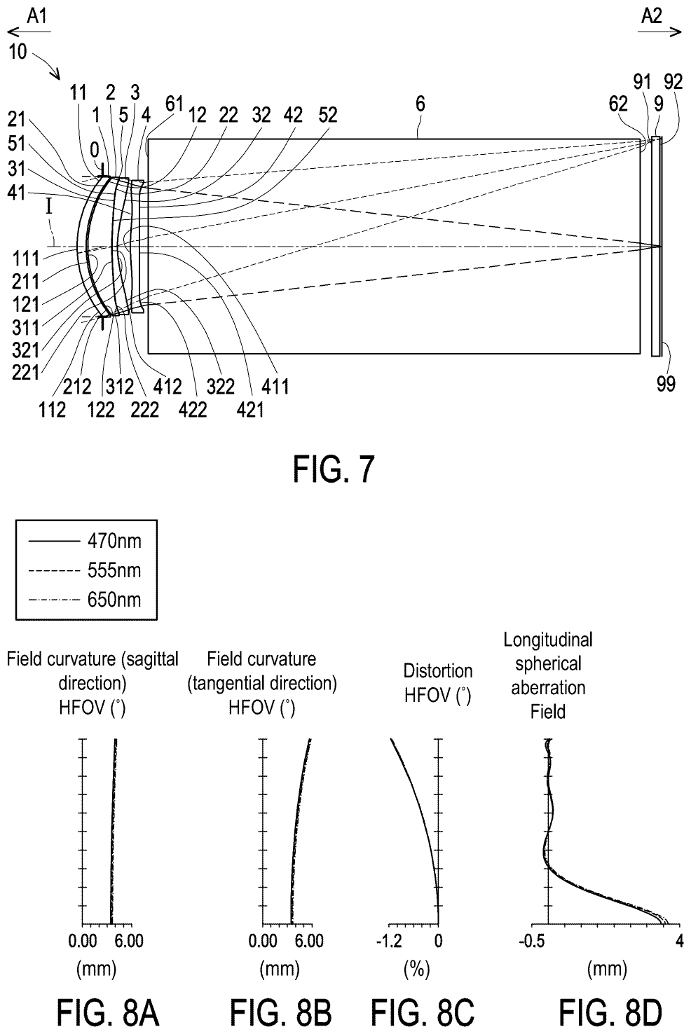

FIG. 6 and FIG. 7 are schematic views illustrating an imaging optical lens according to a first embodiment of the disclosure. FIG. 6 shows the situation where the optical axis I of the optical imaging lens 10 is bent by an optical bending element 6, which is omitted from FIG. 7. FIG. 8A to FIG. 8D are schematic views showing other aberrations and a longitudinal spherical aberration of the optical imaging lens of the first embodiment.

Referring to FIG. 6 and FIG. 7, an optical imaging lens 10 of the first embodiment of the disclosure includes an aperture 0, a first lens element 1, a second lens element 2, a third lens element 3, a fourth lens element 4, an optical bending element 6 and an IR cut filter 9 sequentially arranged along an optical axis I of the optical imaging lens 10 from an object side A1 to an image side A2. When the light emitted by an object to be captured enters the optical imaging lens 10, and passes through the aperture 0, the first lens element 1, the second lens element 2, the third lens element 3, the fourth lens element 4, the optical bending element 6 and the IR cut filter 9, an image is formed on an image plane 99. The optical bending element 6 is disposed between the fourth lens element 4 and the IR cut filter 9. The IR cut filter 9 is disposed between the optical bending element 6 and the image plane 99. It should be added that the object side is the side facing the object to be captured, and the image side is the side facing the image plane 99.

Please refer to FIG. 6. In order to satisfy thin design, an optical bending element 6 is disposed between the fourth lens element 4 and the IR cut filter 9. The optical axis I of the optical imaging lens 10 is bent by the optical bending element 6 into a first optical axis I1 and a second optical axis 12 that is not coincident with the first optical axis I1. The optical bending element 6 may be a prism, a mirror or other appropriate reflective element.

It should be added that the actual optical path is as shown in FIG. 6 instead of the illustration shown in FIG. 7. However, in terms of optical simulation, it is simpler to simulate/calculate using the optical path shown in FIG. 7, and the simulation/calculation results using the optical path shown in FIG. 7 are consistent with the simulation/calculation results using the optical path shown in FIG. 6. Therefore, the following description is provided with reference to a schematic view (for example, FIG. 7) of the optical imaging lens 10 whose optical axis I is not bent by the optical bending element 6.

Referring to FIG. 7, in the embodiment, each of the first lens element 1, the second lens element 2, the third lens element 3, the fourth lens element 4, an adhesive layer 5, the optical bending element 6 and the IR cut filter 9 of the optical imaging lens 10 has an object-side surface 11, 21, 31, 41, 51, 61, 91 facing the object side A1 and allowing the imaging rays to pass through, and an image-side surface 12, 22, 32, 42, 52, 62, 92 facing the image side A2 and allowing the imaging rays to pass through. In this embodiment, the aperture 0 is located between the object to be captured and the first lens element 1.

The image-side surface of the Nth lens element counted from the object side A1 to the image side A2 along the optical axis I is cemented to the object-side surface of the N+1th lens element counted from the object side A1 to the image side A2 along the optical axis I, wherein N is a positive integer greater than or equal to 1 and less than or equal to 3. There is an adhesive layer 5 between the image-side surface of the Nth lens element and the object-side surface of the N+1th lens element. The object-side surface 51 of the adhesive layer 5 is in contact with and complementary to the image-side surface 22 of the second lens element 2. The image-side surface 52 of the adhesive layer 5 is in contact with and complementary to the object-side surface 31 of the third lens element 3. For example, in this embodiment, N=2. That is to say, in this embodiment, the image-side surface 22 of the second lens element 2 is cemented to the object-side surface 31 of the third lens element 3, and there may be the adhesive layer 5 between the image-side surface 22 of the second lens element 2 and the object-side surface 31 of the third lens element 3, but the present disclosure is not limited thereto.

The first lens element 1 has positive refracting power. The optical axis region 111 of the object-side surface 11 of the first lens element 1 is convex, and its periphery region 112 is convex. The optical axis region 121 of the image-side surface 12 of the first lens element 1 is concave, and its periphery region 122 is concave.

The second lens element 2 has positive refracting power. The optical axis region 211 of the object-side surface 21 of the second lens element 2 is convex, and its periphery region 212 is convex. The optical axis region 221 of the image-side surface 22 of the second lens element 2 is concave, and its periphery region 222 is concave. In this embodiment, both the object-side surface 21 and the image-side surface 22 of the second lens element 2 are aspheric surfaces, but the disclosure is not limited thereto.

The third lens element 3 has negative refracting power. The optical axis region 311 of the object-side surface 31 of the third lens element 3 is convex, and its periphery region 312 is convex. The optical axis region 321 of the image-side surface 32 of the third lens element 3 is concave, and its periphery region 322 is concave. In this embodiment, both the object-side surface 31 and the image-side surface 32 of the third lens element 3 are aspheric surfaces, but the disclosure is not limited thereto.

The fourth lens element 4 has positive refracting power. The optical axis region 411 of the object-side surface 41 of the fourth lens element 4 is convex, and its periphery region 412 is convex. The optical axis region 421 of the image-side surface 42 of the fourth lens element 4 is concave, and its periphery region 422 is concave. In this embodiment, both the object-side surface 41 and the image-side surface 42 of the fourth lens element 4 are aspheric surfaces, but the disclosure is not limited thereto.

In the embodiment, only the above-mentioned four lens elements of the optical imaging lens 10 have refracting power.

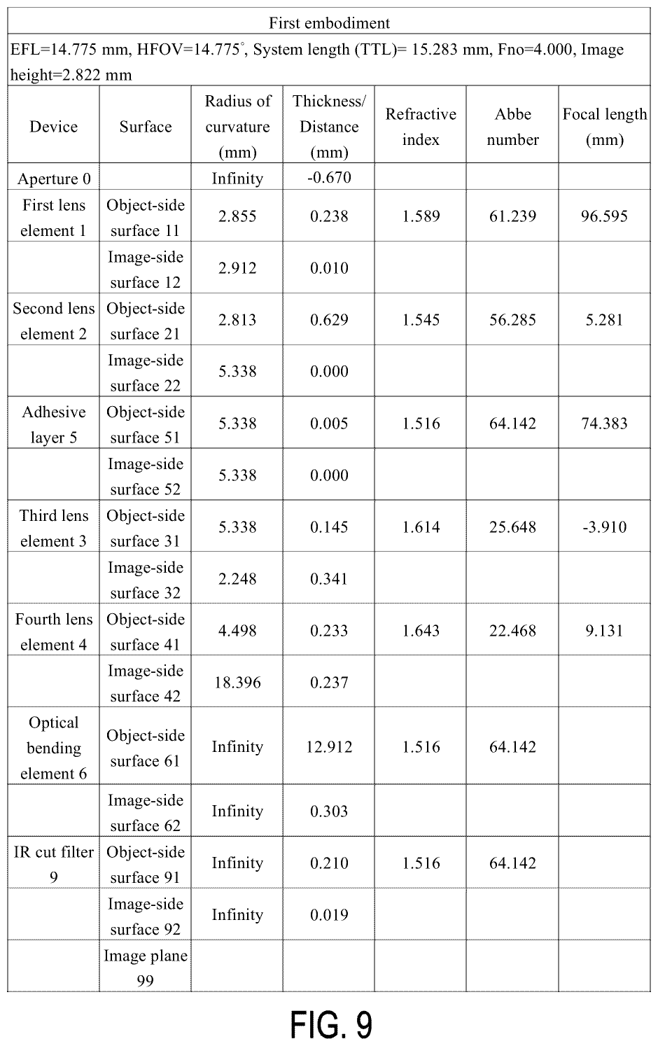

Other detailed optical data of the first embodiment is shown in FIG. 9, with regard to the optical imaging lens 10 of the first embodiment, the effective focal length (EFL) of is 14.775 mm (millimeter), the half field of view (HFOV) is 14.775°, the system length is 15.283 mm, the f-number (Fno) is 4.000, and the image height is 2.822 mm. The system length refers to the distance from the object-side surface 11 of the first lens element 1 to the image plane 99 along the optical axis I.

Moreover, in this embodiment, the object-side surfaces 21, 51, 31, 41 and the image-side surfaces 22, 52, 32 and 42 of the second lens element 2, the adhesive layer 5, the third lens element 3, and the fourth lens element 4, which are eight surfaces in total are aspheric surfaces. The object-side surfaces 21, 51, 31, 41 and image-side surfaces 22, 52, 32 and 42 are even aspheric surfaces. These aspheric surfaces are defined by the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

wherein:
Y: a distance between a point on an aspherical curve and the optical axis I;
Z: a depth of the aspheric surface (a perpendicular distance between the point on the aspheric surface that is spaced by the distance Y from the optical axis I and a tangent plane tangent to a vertex of the aspheric surface on the optical axis I);
R: a radius of curvature of the surface of the lens element close to the optical axis I;
K: a conic constant; and
a₂ᵢ: 2i^{th} aspheric coefficient, wherein the a₂ coefficient of each embodiment is 0.

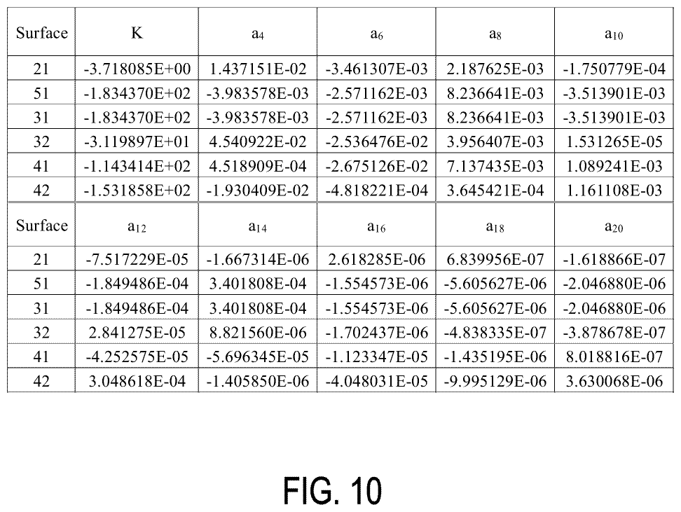

The aspherical coefficients of the object-side surfaces 21, 51, 31, 41 and the image-side surfaces 32 and 42 of the second lens element 2, the adhesive layer 5, the third lens element 3, and the fourth lens element 4 in the equation (1) are shown in FIG. 10. Specifically, the field number 21 of FIG. 10 indicates the aspherical coefficients of the object-side surface 21 of the second lens element 2, and so on.

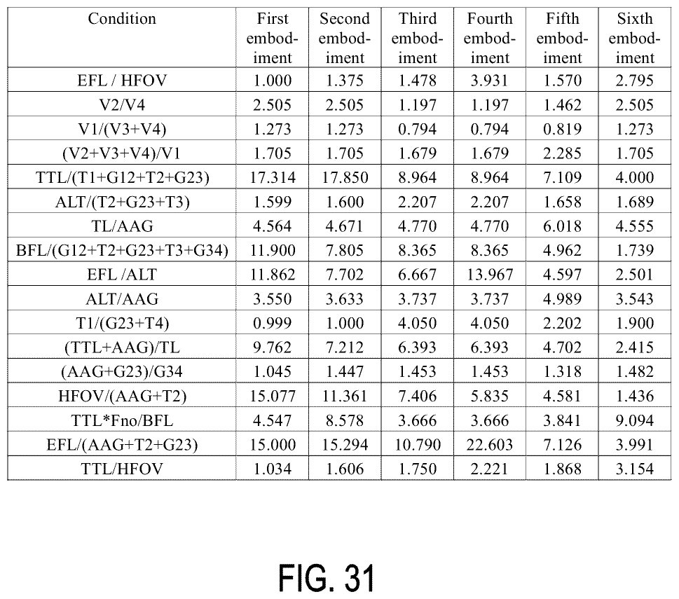

Furthermore, a relationship between important parameters of the optical imaging lens 10 of the first embodiment is shown in FIG. 31.
wherein:
EFL is the effective focal length of the optical imaging lens 10;
HFOV is the half field of view of the optical imaging lens 10;
Fno is the f-number of the optical imaging lens 10;
ImgH is the image height of the optical imaging lens 10;
T1 is a thickness of the first lens element 1 along the optical axis I;
T2 is a thickness of the second lens element 2 along the optical axis I;
T3 is a thickness of the third lens element 3 along the optical axis I;
T4 is a thickness of the fourth lens element 4 along the optical axis I;
G12 is a distance from the image-side surface 12 of the first lens element 1 to the object-side surface 21 of the second lens element 2 along the optical axis I;
G23 is a distance from the image-side surface 22 of the second lens element 2 to the object-side surface 31 of the third lens element 3 along the optical axis I;
G34 is a distance from the image-side surface 32 of the third lens element 3 to the object-side surface 41 of the fourth lens element 4 along the optical axis I;
TL is a distance from the object-side surface 11 of the first lens element 1 to the image-side surface 42 of the fourth lens element 4 along the optical axis I;
TTL is a distance from the object-side surface 11 of the first lens element 1 to the image plane 99 along the optical axis I;
BFL is a distance from the image-side surface 42 of the fourth lens element 4 to the image plane 99 along the optical axis I;
AAG is a sum of the distance from the image-side surface 12 of the first lens element 1 to the object-side surface 21 of the second lens element 2 along the optical axis I, the distance from the image-side surface 22 of the second lens element 1 to the object-side surface 31 of the third lens element 3 along the optical axis I, and the distance from the image-side surface 32 of the third lens element 3 to the object-side surface 41 of the fourth lens element 4 along the optical axis I;
ALT is a sum of the thicknesses of the first lens element 1 through the fourth lens element 4 along the optical axis I, i.e., the sum of thicknesses T1, T2, T3, and T4.

It is further defined that:
G4F is a distance from the fourth lens element 4 to the IR cut filter 9 along the optical axis I;
TF is the thickness of the IR cut filter 9 along the optical axis I;
GFP is a distance from the IR cut filter 9 to the image plane 99 along the optical axis I;
f1 is a focal length of the first lens element 1;
f2 is a focal length of the second lens element 2;
f3 is a focal length of the third lens element 3;
f4 is a focal length of the fourth lens element 4;
n1 is a refractive index of the first lens element 1;
n2 is a refractive index of the second lens element 2;
n3 is a refractive index of the third lens element 3;
n4 is a refractive index of the fourth lens element 4;
ν1 is an Abbe number, which may also be called a dispersion coefficient, of the first lens element 1;
ν2 is an Abbe number of the second lens element 2;
ν3 is an Abbe number of the third lens element 3; and
ν4 is an Abbe number of the fourth lens element 4.

Further, referring to FIG. 8A to FIG. 8D, the diagrams of FIG. 8A and FIG. 8B respectively show a field curvature aberration in a sagittal direction and a field curvature aberration in a tangential direction on the image plane 99 of the first embodiment when the wavelength thereof is 470 nm, 555 nm and 650 nm, the diagram of FIG. 8C shows a distortion aberration on the image plane 99 of the first embodiment when the wavelength thereof is 470 nm, 555 nm and 650 nm. The longitudinal spherical aberration of the first embodiment is as shown in FIG. 8D.

In the two diagrams showing field curvature aberration of FIG. 8A and FIG. 8B, variations of the focal lengths of three representative wavelengths in the whole field of view fall in a range of ±6.00 mm, which shows that the optical system of the first embodiment of the disclosure effectively eliminates aberration. The diagram of distortion aberration of FIG. 8C shows that the distortion aberration of the first embodiment is maintained in a range of ±1.2%, which shows that the distortion aberration of the first embodiment meets the requirement of image quality of the optical system. Accordingly, under the circumstances that the system length is reduced to 15.283 mm, the optical imaging lens of the first embodiment still provides better image quality than the conventional optical lens. Therefore, in the first embodiment, the volume of lens may be reduced, the focal length for capturing may be increased and the image quality may be met while favorable optical performance is maintained. In FIG. 8D which shows the longitudinal spherical aberration of the first embodiment, curves formed by each wavelength are close to each other and are gathered in the middle, which represents that off-axis lights of different heights of each wavelength are gathered around imaging points, and according to a deviation range of the curve of each wavelength, it is learned that deviations of the imaging points of the off-axis lights of different heights are controlled within a range of ±4.0 mm, so that the spherical aberration of the same wavelength is obviously ameliorated in the first embodiment. Moreover, the distances between the three representative wavelengths are rather close, which represents that imaging positions of the lights with different wavelengths are rather close, so that a chromatic aberration is obviously ameliorated.

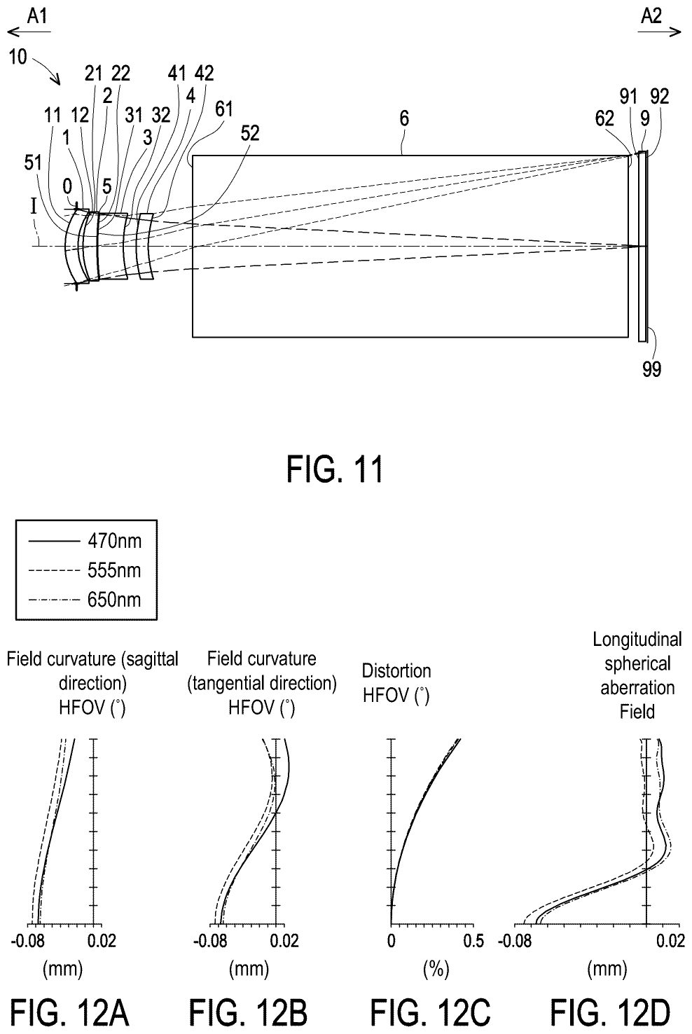

FIG. 11 is a schematic view of an optical imaging lens according to the second embodiment of the disclosure. FIG. 12A to FIG. 12D are schematic views showing other aberrations and a longitudinal spherical aberration of the optical imaging lens of the second embodiment.

First, referring to FIG. 11, the optical imaging lens 10 of the second embodiment of the disclosure is similar to the optical imaging lens 10 of the first embodiment. They differ in that the fourth lens element 4 has negative refracting power, and the parameters of the lens elements (such as radius of curvature of lens element, refracting power of lens element, thickness of lens element, aspheric coefficient of lens element or effective focal length, etc.) are also different. It should be noted that, for clarity, the reference numerals of some optical axis regions and periphery regions that are the same as those of the first embodiment are omitted from FIG. 11.

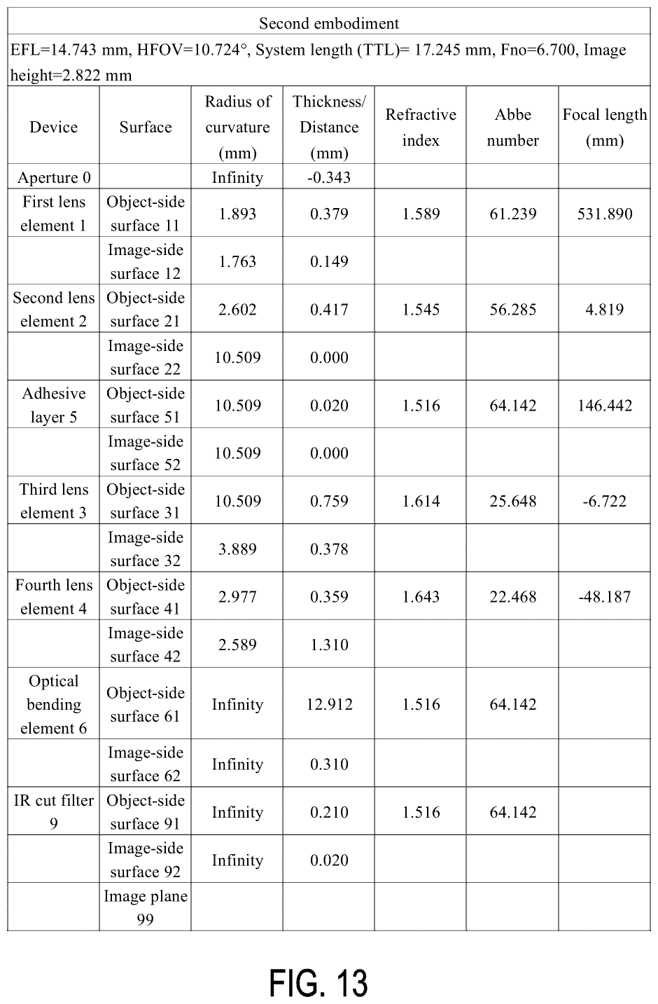

Detailed optical data of the optical imaging lens 10 of the second embodiment is shown in FIG. 13, and in the second embodiment, the effective focal length EFL of the optical imaging lens 10 is 14.743 mm, the half field of view HFOV is 10.724°, the system length TTL is 17.245 mm, the f-number Fno is 6.700, and the image height is 2.822 mm.

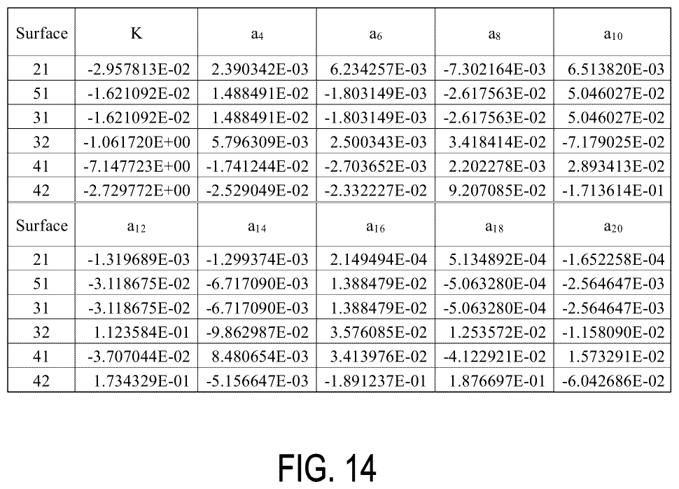

The aspherical coefficients of the object-side surfaces 21, 51, 31, 41 and the image-side surfaces 32 and 42 of the second lens element 2, the adhesive layer 5, the third lens element 3 and fourth lens element 4 in the equation (1) according to the second embodiment are shown in FIG. 14.

Furthermore, the relationship between important parameters of the optical imaging lens 10 of the second embodiment is shown in FIG. 31.

In the two diagrams showing field curvature aberration of FIG. 12A and FIG. 12B, variations of the focal lengths of three representative wavelengths in the whole field of view fall in a range of ±0.08 mm. The diagram of distortion aberration of FIG. 8C shows that the distortion aberration of the second embodiment is maintained in a range of ±0.5%. The longitudinal spherical aberration of the second embodiment of the disclosure is as shown in FIG. 12D, deviations of the imaging points of the off-axis rays at different heights are controlled in a range of ±0.08 mm.

The thickness difference between the optical axis of the lens element and the periphery region of the optical imaging lens 10 of the second embodiment is less than that of the first embodiment, and the manufacturing process is easy and therefore the yield of the second embodiment is higher. Besides, the distortion aberration of the second embodiment is less than that of the first embodiment.

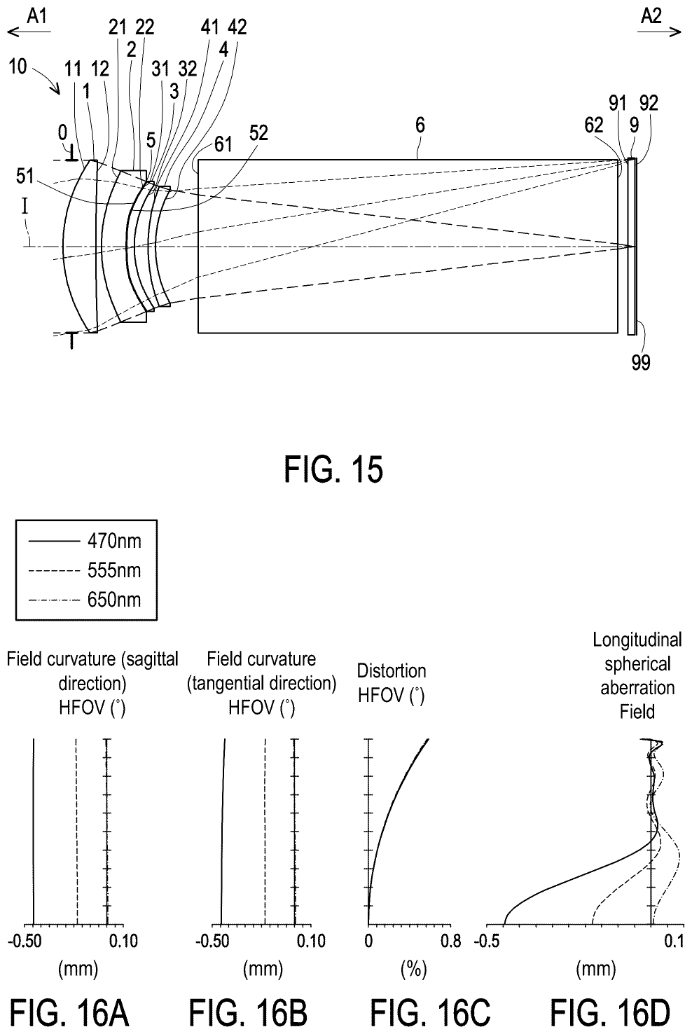

FIG. 15 is a schematic view of an optical imaging lens according to the third embodiment of the disclosure. FIG. 16A to FIG. 16D are schematic views showing other aberrations and a longitudinal spherical aberration of the optical imaging lens of the third embodiment.

First, referring to FIG. 15, the optical imaging lens 10 of the third embodiment of the disclosure is similar to the optical imaging lens 10 of the first embodiment. They differ in that the fourth lens element 4 has negative refracting power, and the parameters of the lens elements (such as radius of curvature of lens element, refracting power of lens element, thickness of lens element, aspheric coefficient of lens element or effective focal length, etc.) are also different. It should be noted that, for clarity, the reference numerals of some optical axis regions and periphery regions that are the same as those of the first embodiment are omitted from FIG. 15.

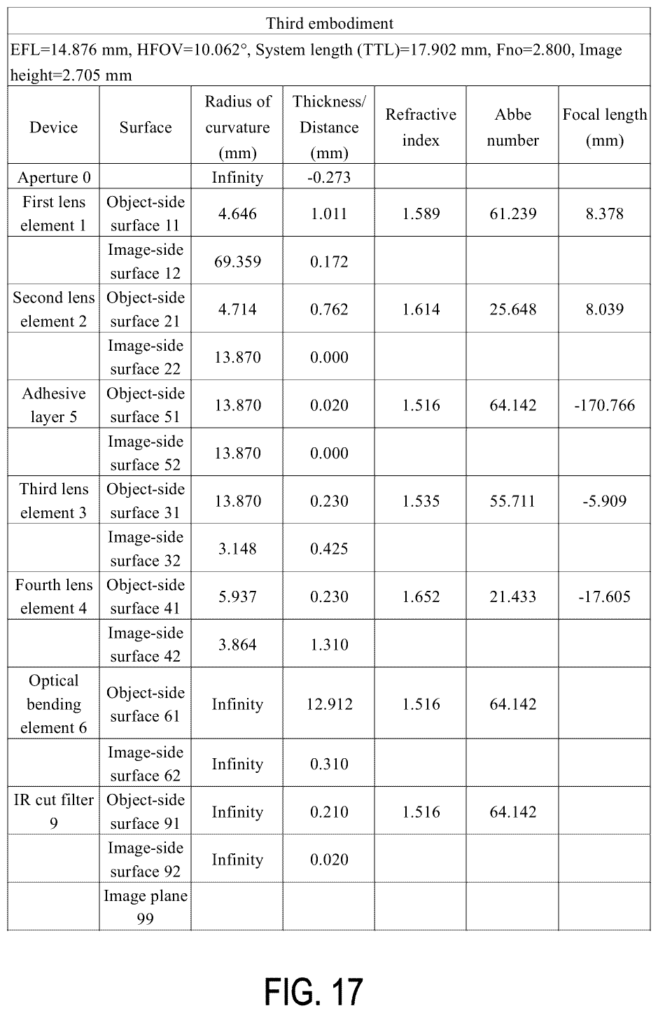

Detailed optical data of the optical imaging lens 10 of the third embodiment is shown in FIG. 17, and in the third embodiment, the effective focal length EFL of the optical imaging lens 10 is 14.876 mm, the half field of view HFOV is 10.062°, the system length TTL is 17.902 mm, the f-number Fno is 2.800, and the image height is 2.705 mm.

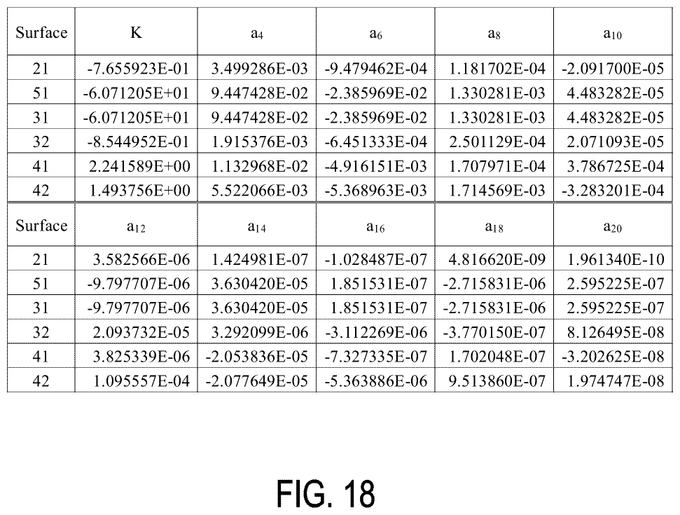

The aspherical coefficients of the object-side surfaces 21, 51, 31, 41 and the image-side surfaces 32 and 42 of the second lens element 2, the adhesive layer 5, the third lens element 3 and fourth lens element 4 in the equation (1) according to the third embodiment are shown in FIG. 18.

Furthermore, the relationship between important parameters of the optical imaging lens 10 of the third embodiment is shown in FIG. 31.

In the two diagrams showing field curvature aberration of FIG. 16A and FIG. 16B, variations of the focal lengths of three representative wavelengths in the whole field of view fall in a range of ±0.50 mm. The diagram of distortion aberration of FIG. 16C shows that the distortion aberration of the third embodiment is maintained in a range of ±0.8%. The longitudinal spherical aberration of the third embodiment of the disclosure is as shown in FIG. 16D, deviations of the imaging points of the off-axis rays at different heights are controlled in a range of ±0.5 mm.

The f-number Fno of the third embodiment is less than the f-number Fno of the first embodiment. That is to say, the aperture of the third embodiment is greater than that of the first embodiment. The distortion aberration of the third embodiment is less than that of the first embodiment.

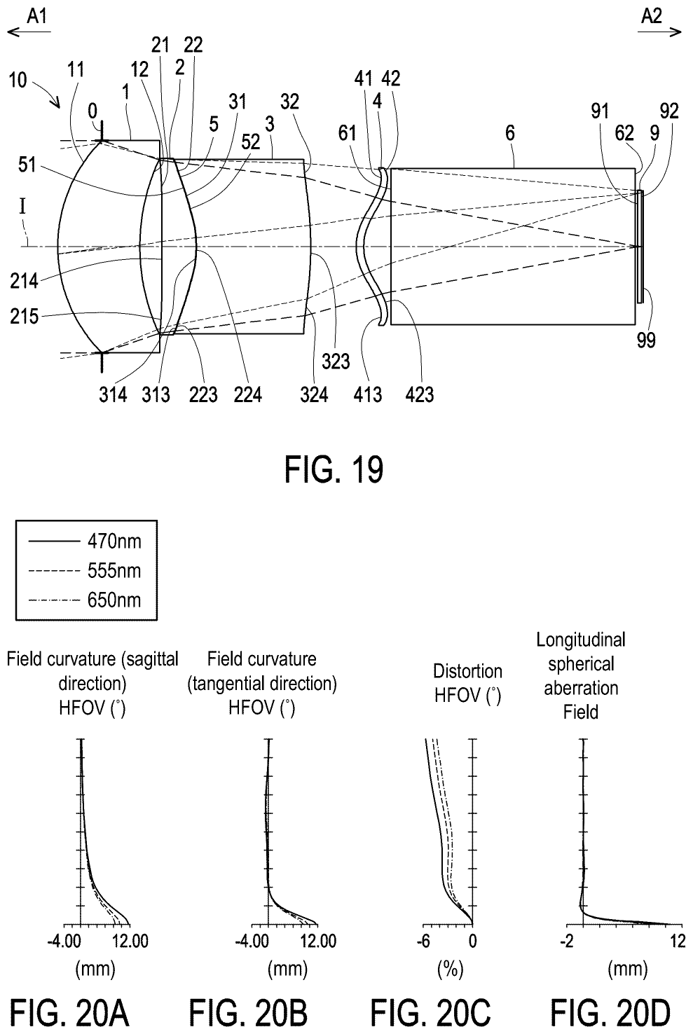

FIG. 19 is a schematic view of an optical imaging lens according to the fourth embodiment of the disclosure. FIG. 20A to FIG. 20D are schematic views showing other aberrations and a longitudinal spherical aberration of the optical imaging lens of the fourth embodiment.

First, referring to FIG. 19, the optical imaging lens 10 of the fourth embodiment of the disclosure is similar to the optical imaging lens 10 of the first embodiment. They differ in the following aspects. The optical axis region 214 of the object-side surface 21 of the second lens element 2 is concave. The periphery region 215 of the object-side surface 21 of the second lens element 2 is concave. The optical axis region 224 of the image-side surface 22 of the second lens element 2 is convex. The periphery region 223 of the image-side surface 22 of the second lens element 2 is convex. The optical axis region 314 of the object-side surface 31 of the third lens element 3 is concave. The periphery region 313 of the object-side surface 31 of the third lens element 3 is concave. The optical axis region 323 of the image-side surface 32 of the third lens element 3 is convex. The periphery region 324 of the image-side surface 32 of the third lens element 3 is convex. The fourth lens element 4 has negative refracting power. The periphery region 413 of the object-side surface 41 of the fourth lens element 4 is concave. The periphery region 423 of the image-side surface 42 of the fourth lens element 4 is convex. Besides, the parameters of the lens elements (such as radius of curvature of lens element, refracting power of lens element, thickness of lens element, aspheric coefficient of lens element or effective focal length, etc.) are also different. It should be noted that, for clarity, the reference numerals of some optical axis regions and periphery regions that are the same as those of the first embodiment are omitted from FIG. 19.

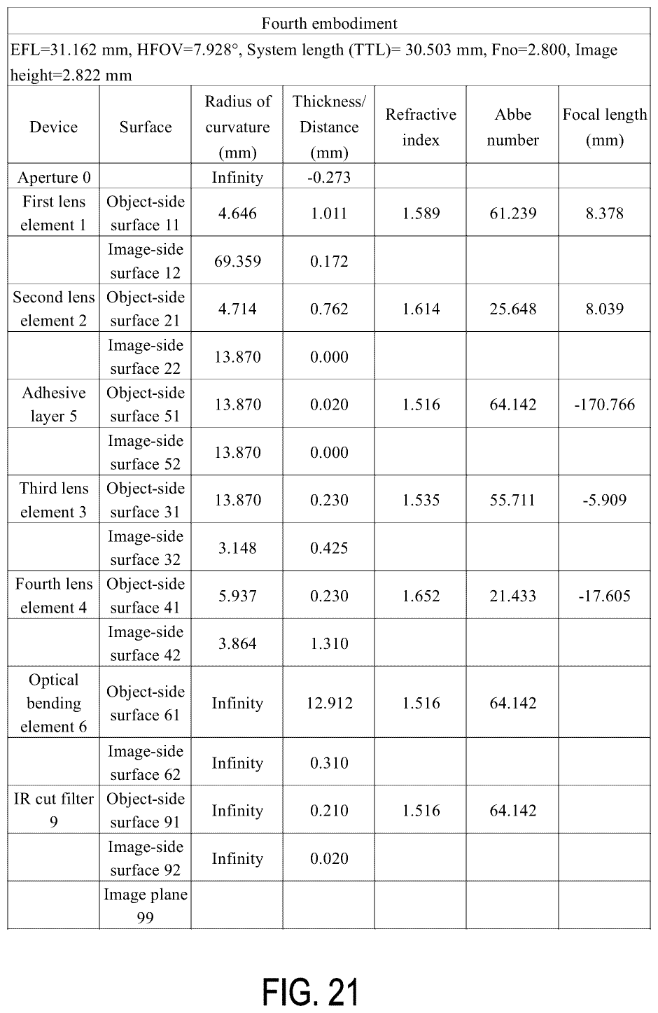

Detailed optical data of the optical imaging lens 10 of the fourth embodiment is shown in FIG. 21, and in the fourth embodiment, the effective focal length EFL of the optical imaging lens 10 is 31.162 mm, the half field of view HFOV is 7.928°, the system length TTL is 30.503 mm, the f-number Fno is 2.800, and the image height is 2.822 mm.

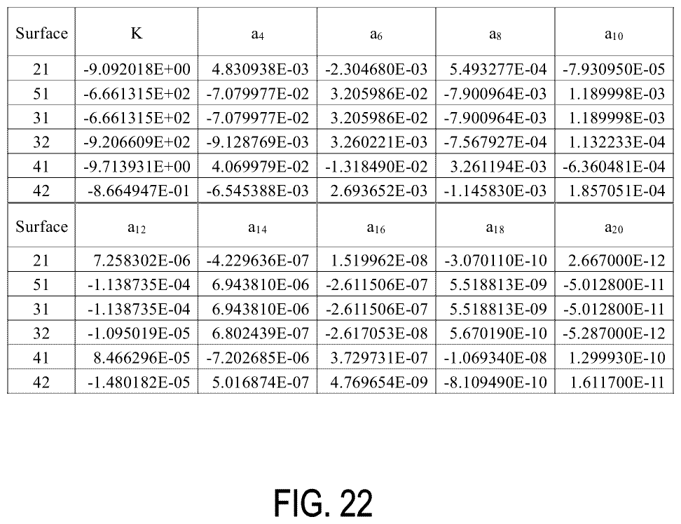

The aspherical coefficients of the object-side surfaces 21, 51, 31, 41 and the image-side surfaces 32 and 42 of the second lens element 2, the adhesive layer 5, the third lens element 3 and fourth lens element 4 in the equation (1) according to the fourth embodiment are shown in FIG. 22.

Furthermore, the relationship between important parameters of the optical imaging lens 10 of the fourth embodiment is shown in FIG. 31.

In the two diagrams showing field curvature aberration of FIG. 20A and FIG. 20B, variations of the focal lengths of three representative wavelengths in the whole field of view fall in a range of ±12.00 mm. The diagram of distortion aberration of FIG. 20C shows that the distortion aberration of the fourth embodiment is maintained in a range of ±6%. The longitudinal spherical aberration of the fourth embodiment of the disclosure is as shown in FIG. 20D, deviations of the imaging points of the off-axis rays at different heights are controlled in a range of ±12 mm.

The f-number Fno of the fourth embodiment is less than the f-number Fno of the first embodiment. That is to say, the aperture of the fourth embodiment is greater than that of the first embodiment. The effective focal length of the fourth embodiment is longer than that of the first embodiment, and therefore making a longer capturing distance applicable.

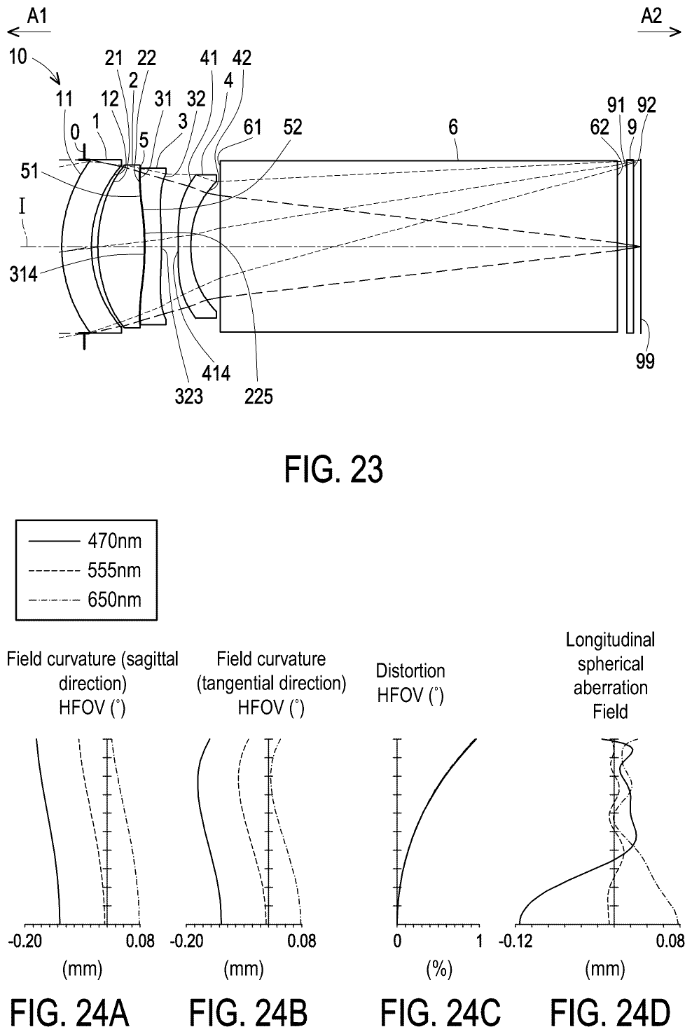

FIG. 23 is a schematic view of an optical imaging lens according to the fifth embodiment of the disclosure. FIG. 24A to FIG. 24D are schematic views showing other aberrations and a longitudinal spherical aberration of the optical imaging lens of the fifth embodiment.

First, referring to FIG. 23, the optical imaging lens 10 of the fifth embodiment of the disclosure is similar to the optical imaging lens 10 of the first embodiment. They differ in the following aspects. The first lens element 1 has negative refracting power. The optical axis region 225 of the image-side surface 22 of the second lens element 2 is convex. The third lens element 3 has positive refracting power. The optical axis region 314 of the object-side surface 31 of the third lens element 3 is concave. The optical axis region 323 of the image-side surface 32 of the third lens element 3 is convex. The fourth lens element 4 has negative refracting power. The optical axis region 414 of the object-side surface 41 of the fourth lens element 4 is concave. Besides, the parameters of the lens elements (such as radius of curvature of lens element, refracting power of lens element, thickness of lens element, aspheric coefficient of lens element or effective focal length, etc.) are also different. It should be noted that, for clarity, the reference numerals of some optical axis regions and periphery regions that are the same as those of the first embodiment are omitted from FIG. 23.

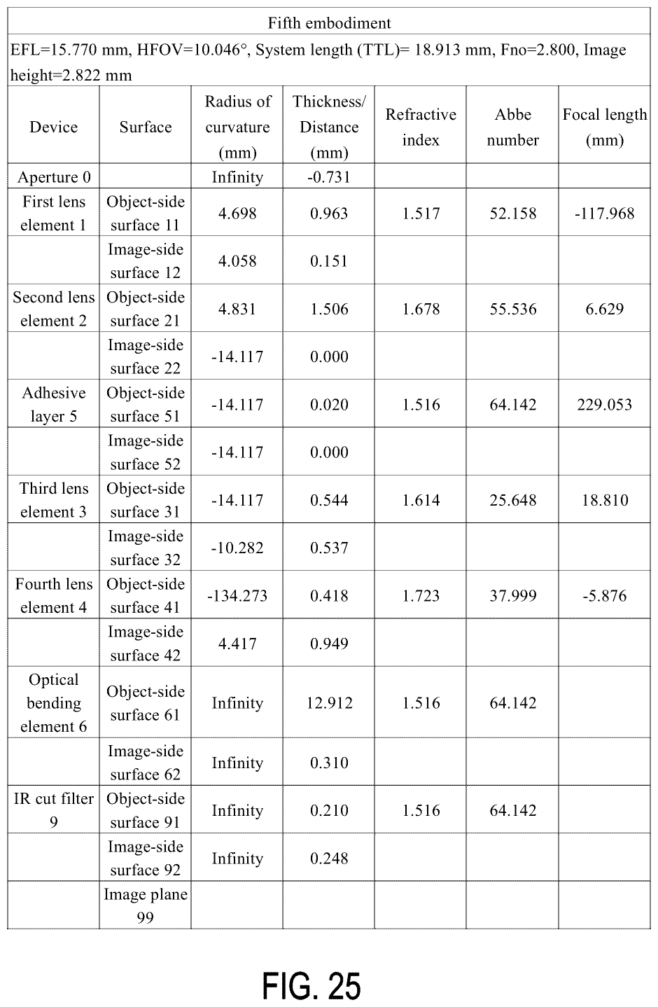

Detailed optical data of the optical imaging lens 10 of the fifth embodiment is shown in FIG. 25, and in the fifth embodiment, the effective focal length EFL of the optical imaging lens 10 is 15.770 mm, the half field of view HFOV is 10.046°, the system length TTL is 18.913 mm, the f-number Fno is 2.800, and the image height is 2.822 mm.

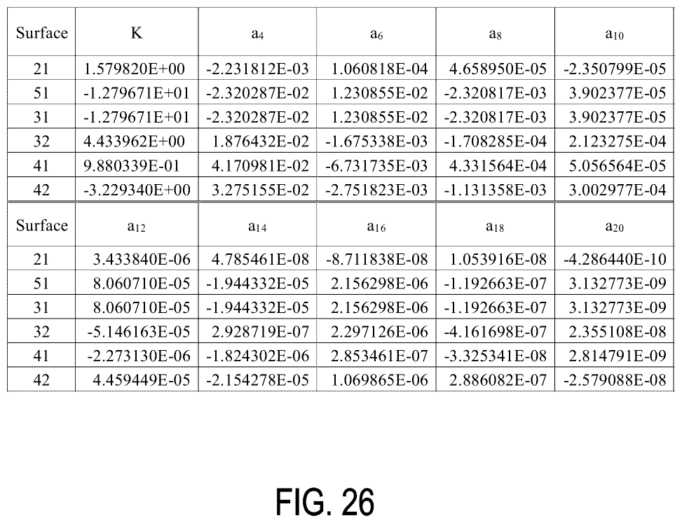

The aspherical coefficients of the object-side surfaces 21, 51, 31, 41 and the image-side surfaces 32 and 42 of the second lens element 2, the adhesive layer 5, the third lens element 3 and fourth lens element 4 in the equation (1) according to the fifth embodiment are shown in FIG. 26.

Furthermore, the relationship between important parameters of the optical imaging lens 10 of the fifth embodiment is shown in FIG. 31.

In the two diagrams showing field curvature aberration of FIG. 24A and FIG. 24B, variations of the focal lengths of three representative wavelengths in the whole field of view fall in a range of ±0.20 mm. The diagram of distortion aberration of FIG. 24C shows that the distortion aberration of the fifth embodiment is maintained in a range of ±1%. The longitudinal spherical aberration of the fifth embodiment of the disclosure is as shown in FIG. 24D, deviations of the imaging points of the off-axis rays at different heights are controlled in a range of ±0.12 mm.

The f-number Fno of the fifth embodiment is less than the f-number Fno of the first embodiment. That is to say, the aperture of the fifth embodiment is greater than that of the first embodiment.

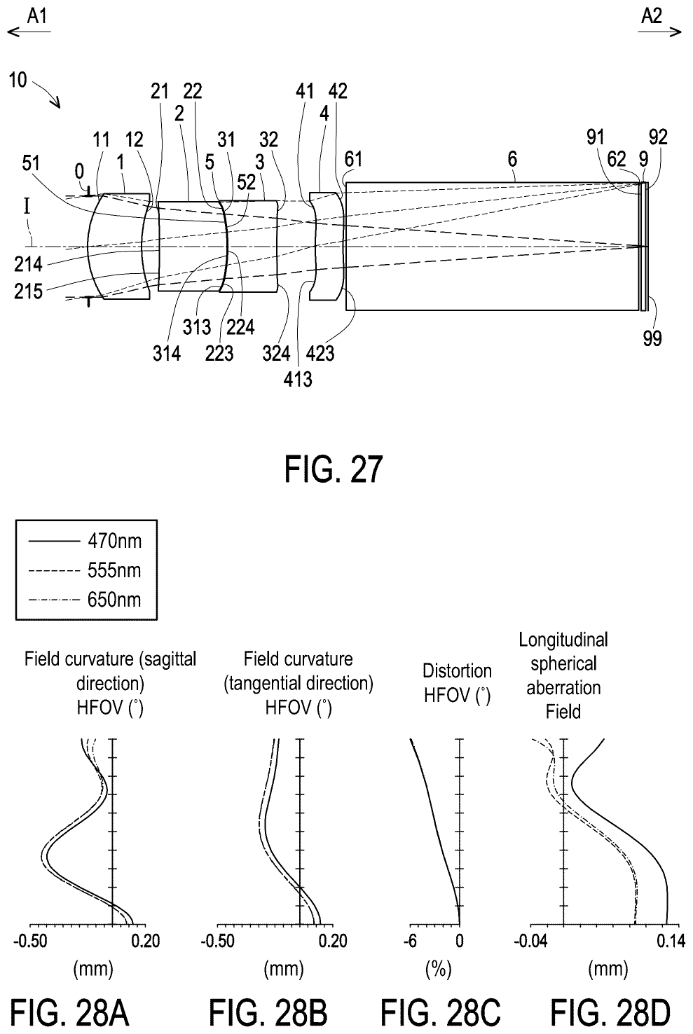

FIG. 27 is a schematic view of an optical imaging lens according to the sixth embodiment of the disclosure. FIG. 28A to FIG. 28D are schematic views showing other aberrations and a longitudinal spherical aberration of the optical imaging lens of the sixth embodiment.

First, referring to FIG. 27, the optical imaging lens 10 of the sixth embodiment of the disclosure is similar to the optical imaging lens 10 of the first embodiment. They differ in the following aspects. The optical axis region 214 of the object-side surface 21 of the second lens element 2 is concave. The periphery region 215 of the object-side surface 21 of the second lens element 2 is concave. The optical axis region 224 of the image-side surface 22 of the second lens element 2 is convex. The periphery region 223 of the image-side surface 22 of the second lens element 2 is convex. The optical axis region 314 of the object-side surface 31 of the third lens element 3 is concave. The periphery region 313 of the object-side surface 31 of the third lens element 3 is concave. The periphery region 324 of the image-side surface 32 of the third lens element 3 is convex. The fourth lens element 4 has negative refracting power. The periphery region 413 of the object-side surface 41 of the fourth lens element 4 is concave. The periphery region 423 of the image-side surface 42 of the fourth lens element 4 is convex. Besides, the parameters of the lens elements (such as radius of curvature of lens element, refracting power of lens element, thickness of lens element, aspheric coefficient of lens element or effective focal length, etc.) are also different. It should be noted that, for clarity, the reference numerals of some optical axis regions and periphery regions that are the same as those of the first embodiment are omitted from FIG. 27.

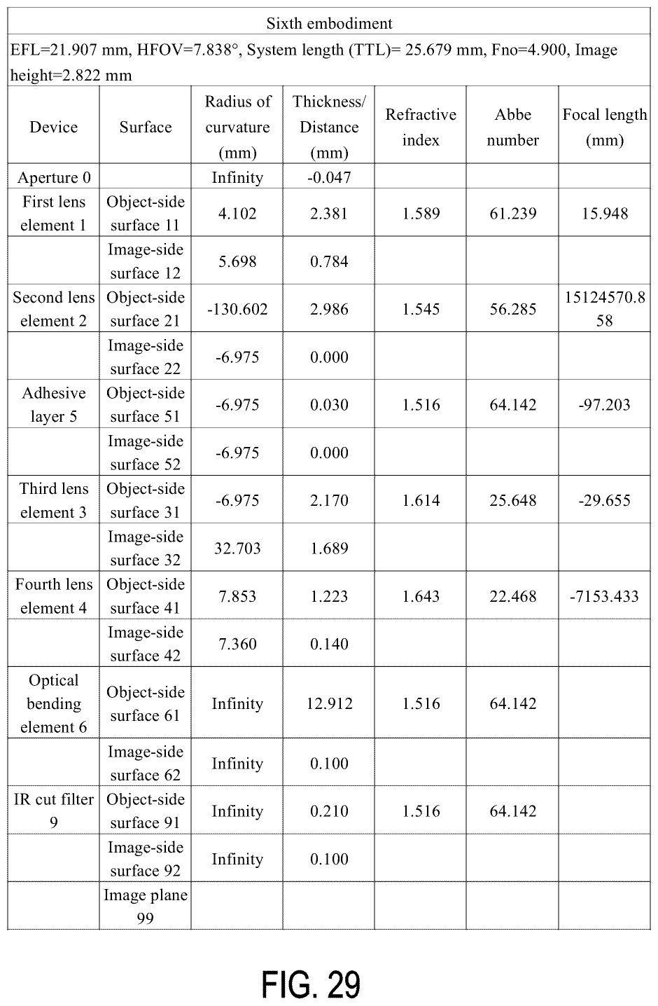

Detailed optical data of the optical imaging lens 10 of the sixth embodiment is shown in FIG. 29, and in the sixth embodiment, the effective focal length EFL of the optical imaging lens 10 is 21.907 mm, the half field of view HFOV is 7.838°, the system length TTL is 25.679 mm, the f-number Fno is 4.900, and the image height is 2.822 mm.

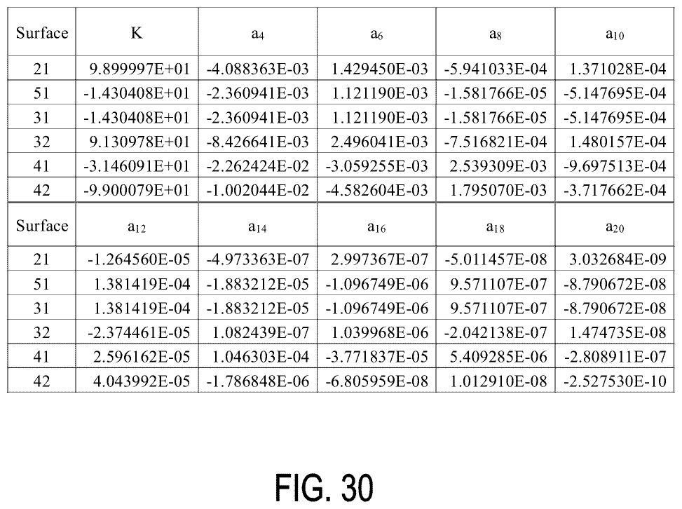

The aspherical coefficients of the object-side surfaces 21, 51, 31, 41 and the image-side surfaces 32 and 42 of the second lens element 2, the adhesive layer 5, the third lens element 3 and fourth lens element 4 in the equation (1) according to the sixth embodiment are shown in FIG. 30.

Furthermore, the relationship between important parameters of the optical imaging lens 10 of the sixth embodiment is shown in FIG. 31.

In the two diagrams showing field curvature aberration of FIG. 28A and FIG. 28B, variations of the focal lengths of three representative wavelengths in the whole field of view fall in a range of ±0.50 mm. The diagram of distortion aberration of FIG. 24C shows that the distortion aberration of the sixth embodiment is maintained in a range of ±6%. The longitudinal spherical aberration of the sixth embodiment of the disclosure is as shown in FIG. 28D, deviations of the imaging points of the off-axis rays at different heights are controlled in a range of ±0.14 mm.

The thickness difference between the optical axis of the lens element and the periphery region of the optical imaging lens 10 of the sixth embodiment is less than that of the first embodiment, and the manufacturing process is easy and therefore the yield of the sixth embodiment is higher. Besides, the effective focal length of the sixth embodiment is longer than that of the first embodiment, and therefore making a longer capturing distance applicable.

Further refer to FIG. 31 for reference, FIG. 31 shows optical parameters and relation values thereof according to the first through the sixth embodiments of the disclosure.

The following conditional formulae are provided to keep the lens thickness and gaps in a suitable range so that the parameters are not so great to jeopardize the thinning of the entire optical imaging lens or are not too small to affect or bring increased difficulty in fabrication or assembly of the optical imaging lens.

In the optical imaging lens 10 according to the embodiment of the present disclosure, the following conditional expression is further satisfied: EFL/HFOV≥1.000 mm/°, where the preferred range is 1.000 mm/°≤EFL/HFOV≤4.300 mm/°.

In the optical imaging lens 10 according to the embodiment of the present disclosure, the following conditional expression is further satisfied: TTL/(T1+G12+T2+G23)≥4.000, where the preferred range is 4.000≤TTL/(T1+G12+T2+G23)≤19.600.

In the optical imaging lens 10 according to the embodiment of the present disclosure, the following conditional expression is further satisfied: ALT/(T2+G23+T3)≥1.600, where the preferred range is 1.600≤ALT/(T2+G23+T3)≤2.400.

In the optical imaging lens 10 according to the embodiment of the present disclosure, the following conditional expression is further satisfied: TL/AAG≥4.500, where the preferred range is 4.500≤TL/AAG≤6.620, and the more preferred range is 4.500≤TL/AAG≤5.200.

In the optical imaging lens 10 according to the embodiment of the present disclosure, the following conditional expression is further satisfied: BFL/(G12+T2+G23+T3+G34)≥0.800, where the preferred range is 0.800≤BFL/(G12+T2+G23+T3+G34)≤13.000.

In the optical imaging lens 10 according to the embodiment of the present disclosure, the following conditional expression is further satisfied: EFL/ALT≥2.500, where the preferred range is 2.500≤EFL/ALT≤15.300.

In the optical imaging lens 10 according to the embodiment of the present disclosure, the following conditional expression is further satisfied: ALT/AAG≥3.000, where the preferred range is 3.000≤ALT/AAG≤5.400, and the more preferred range is 3.000≤TL/AAG≤4.100.

In the optical imaging lens 10 according to the embodiment of the present disclosure, the following conditional expression is further satisfied: T1/(G23+T4)≥1.000, where the preferred range is 1.000≤T1/(G23+T4)≤4.400.

In the optical imaging lens 10 according to the embodiment of the present disclosure, the following conditional expression is further satisfied: (TTL+AAG)/TL≥2.000, where the preferred range is 2.000≤(TTL+AAG)/TL≤10.700.

In the optical imaging lens 10 according to the embodiment of the present disclosure, the following conditional expression is further satisfied: (AAG+G23)/G34≤1.500, where the preferred range is 0.900≤(AAG+G23)/G34≤1.500.

In the optical imaging lens 10 according to the embodiment of the present disclosure, the following conditional expression is further satisfied: HFOV/(AAG+T2)≤15.100°/mm, where the preferred range is 1.300°/mm≤HFOV/(AAG+T2)≤15.100°/mm.

In the optical imaging lens 10 according to the embodiment of the present disclosure, the following conditional expression is further satisfied: TTL.Fno/BFL≤9.000, where the preferred range is 3.300≤TTL·Fno/BFL≤9.000.

In the optical imaging lens 10 according to the embodiment of the present disclosure, the following conditional expression is further satisfied: EFL/(AAG+T2+G23)≥3.500, where the preferred range is 3.500≤EFL/(AAG+T2+G23)≤24.800.

In the optical imaging lens 10 according to the embodiment of the present disclosure, the following conditional expression is further satisfied: TTL/HFOV≥0.900 mm/°, where the preferred range is 0.900 mm/°≤TTL/HFOV≤3.400 mm/°.

In addition, any combination of the parameters of the embodiments may be selected to increase the limitation of the lens elements to facilitate the design of the lens elements of the same configuration as the present disclosure. In view of the unpredictability of optical system design, under the configuration of the disclosure, the length of the telephoto lens according to the embodiments of the disclosure may be shortened, the effective focal length may be increased, and the imaging quality may be enhanced, or the assembly yield may be improved when the conditions above are satisfied, such that the issues of the related art may be resolved.

The maximum and minimum numeral values derived from the combinations of the optical parameters disclosed in the embodiments of the disclosure may all be applicable and enable people skill in the pertinent art to implement the disclosure.

The exemplary limiting expressions above may also be selectively combined and applied to the embodiments of the present disclosure, and are not limited thereto. When implementing of the present disclosure, in addition to the expressions above, detailed structures such as arrangements of convex and concave curved surfaces may be designed for a single lens element or universally for multiple lens elements to enhance the control of system performance and/or resolution. It should be noted that the details need to be selectively combined and applied to other embodiments of the present disclosure under the condition of no conflict.

Based on the above, the optical imaging lens 10 in the embodiment of the disclosure can achieve the following effects and advantages.
1. When the optical axis region 111 of the object-side surface 11 of the first lens element 1 is convex, and the second lens element 2 has positive refracting power, it is possible to effectively converge the incident ray; the periphery region 322 of the image-side surface 32 of the third lens element 3 is concave in combination with the periphery region 422 of the image-side surface 42 of the fourth lens element 4 being concave, it is possible to correct edge aberrations of optical imaging lens 10.
2. When the optical axis region 111 of the object-side surface 11 of the first lens element 1 is convex, and the second lens element 2 has positive refracting power, it is possible to effectively converge the incident ray; the third lens element 3 has negative refracting power in combination with the optical axis region 421 of the image-side surface 42 of the fourth lens element 4 being concave, it is possible to correct the aberrations caused by the first two lens elements.
3. When the second lens element 2 has positive refracting power, it is possible to effectively converge the incident ray; the third lens element 3 has negative refracting power in combination with the optical axis region 411 of the object-side surface 41 of the fourth lens element 4 being convex and the optical axis region 421 of the image-side surface 42 of the fourth lens element 4 being concave, it is possible to correct the aberrations caused by the first two lens elements.
4. When the second and the third technical solutions further satisfy that the first lens element 1 has positive refracting power, the overall focusing function of the system may be improved.
5. Further to the first to fourth technical solutions, when the optical imaging lens 10 further satisfies that there is a set of lens elements formed by cementing the image-side surface of the Nth lens element to the object-side surface of the N+1th lens element, N is a positive integer greater than or equal to 1 and less than or equal to 3, and when the proportional relationship EFL/Fno>2.200 mm is satisfied, the following advantages may be achieved:
a) Cementing the lens elements may help to reduce the deformation of the lens elements and lens barrel caused by the shrinkage of the paste (i.e. adhesive layer 5) when assembling the module.
b) During assembly of the cemented lens elements, there is no need to make adjustment to the lens elements separately, so it is easier to assemble the module and the yield rate may be enhanced.
c) By cementing the lens elements, for example: the image-side surface 22 of the second lens element 2 is cemented to the object-side surface 31 of the third lens element 3, there is no need to perform additional surface treatment (such as coating) for these lens elements.
6. There is a paste thickness between the cemented lens elements (i.e. the thickness of the adhesive layer 5 on the optical axis I). The paste thickness may not exceed 0.05 mm to prevent excessively thick paste from affecting the cementing effect and optical quality of the lens elements. The preferred paste thickness is less than or equal to 0.03 mm.
7. When the optical imaging lens 10 is designed with the second lens element 2 being cemented to the third lens element 3, the structure of the module is the strongest and best helps to prevent the paste (i.e. adhesive layer 5) from shrinking and causing deformation of the lens elements or lens barrel.
8. When the first lens element 1 is made of glass material, the focusing effect of the overall system may be enhanced and the durability of the lens element may be enhanced.
9. When the material of the lens elements satisfies the following conditional expression, chromatic aberration may be effectively improved, so that the optical imaging lens 10 has a good imaging quality.

In the optical imaging lens 10 of the embodiment of the disclosure, the following conditional expression is further satisfied: V2/V4≥1.200, and the preferred range is 1.200≤V2/V4≤2.700.

In the optical imaging lens 10 of the embodiment of the disclosure, the following conditional expression is further satisfied: V1/(V3+V4)≥0.790, and the preferred range is 0.790≤V1/(V3+V4)≤1.400.

In the optical imaging lens 10 of the embodiment of the disclosure, the following conditional expression is further satisfied: (V2+V3+V4)/V1≤2.300, and the preferred range is 1.500≤(V2+V3+V4)/V1≤2.300. When the first lens element 1 has positive refracting power and the third lens element 3 has negative refracting power, with the ratio of the materials satisfying (V2+V3+V4)/V1≤1.800, it is possible to correct aberrations of the optical imaging lens 10 more effectively.

The contents in the embodiments of the disclosure include but are not limited to a focal length, a thickness of a lens element, an Abbe number, or other optical parameters. For example, in the embodiments of the disclosure, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the disclosure. The aforementioned description is for exemplary explanation, but the disclosure is not limited thereto.

The embodiments of the disclosure are all implementable. In addition, a combination of partial features in a same embodiment can be selected, and the combination of partial features can achieve the unexpected result of the disclosure with respect to the prior art. The combination of partial features includes but is not limited to the surface shape of a lens element, refracting power, a conditional expression or the like, or a combination thereof. The description of the embodiments is for explaining the specific embodiments of the principles of the disclosure, but the disclosure is not limited thereto. Specifically, the embodiments and the drawings are for exemplifying, but the disclosure is not limited thereto.

What is claimed is:

1. An optical imaging lens, comprising a first lens element, a second lens element, a third lens element, and a fourth lens element sequentially arranged along an optical axis from an object side to an image side, wherein each of the first lens element to the fourth lens element comprises an object-side surface facing the object side and allowing imaging rays to pass through and an image-side surface facing the image side and allowing the imaging rays to pass through;
an optical axis region on the object-side surface of the first lens element is convex;
the second lens element has positive refracting power;
a periphery region of the image-side surface of the third lens element is concave;
a periphery region of the image-side surface of the fourth lens element is concave;
wherein lens elements of the optical imaging lens only comprise the first lens element to the fourth lens element, an image-side surface of a Nth lens element counted from the object side to the image side along the optical axis is cemented to an object-side surface of a N+1th lens element counted from the object side to the image side along the optical axis, and N is a positive integer greater than or equal to 1 and less than or equal to 3;
wherein the optical imaging lens satisfies: EFL/Fno≥2.200 mm, wherein EFL is an effective focal length of the optical imaging lens, and Fno is a f-number of the optical imaging lens.

2. The optical imaging lens according to claim 1, wherein the optical imaging lens satisfies the following conditional expression:
EFL/HFOV≥1.000 mm/°, wherein HFOV is a half field of view of the optical imaging lens.

3. The optical imaging lens according to claim 1, wherein the optical imaging lens satisfies the following conditional expression:
(V2+V3+V4)/V1≤2.300, wherein V2 is an Abbe number of the second lens element, V3 is an Abbe number of the third lens element, V4 is an Abbe number of the fourth lens element, and V1 is an Abbe number of the first lens element.

4. The optical imaging lens according to claim 1, wherein the optical imaging lens satisfies the following conditional expression:
TL/AAG≥4.500, wherein TL is a distance from the object-side surface of the first lens element to the image-side surface of the fourth lens element along the optical axis, and AAG is a sum of a distance from the image-side surface of the first lens element to the object-side surface of the second lens element along the optical axis, a distance from the image-side surface of the second lens element to the object-side surface of the third lens element along the optical axis, and a distance from the image-side surface of the third lens element to the object-side surface of the fourth lens element along the optical axis.

5. The optical imaging lens according to claim 1, wherein the optical imaging lens satisfies the following conditional expression:
ALT/AAG≥3.000, wherein ALT is a sum of thicknesses of the first lens element through the fourth lens element along the optical axis, and AAG is a sum of a distance from the image-side surface of the first lens element to the object-side surface of the second lens element along the optical axis, a distance from the image-side surface of the second lens element to the object-side surface of the third lens element along the optical axis, and a distance from the image-side surface of the third lens element to the object-side surface of the fourth lens element along the optical axis.

6. The optical imaging lens according to claim 1, wherein the optical imaging lens satisfies the following conditional expression:
TTL/(T1+G12+T2+G23)≥4.000, wherein TTL is a distance from the object-side surface of the first lens element to an image plane along the optical axis, T1 is a thickness of the first lens element along the optical axis, G12 is a distance from the image-side surface of the first lens element to the object-side surface of the second lens element along the optical axis, T2 is a thickness of the second lens element along the optical axis, and G23 is a distance from the image-side surface of the second lens element to the object-side surface of the third lens element along the optical axis.

7. An optical imaging lens, comprising a first lens element, a second lens element, a third lens element, and a fourth lens element sequentially arranged along an optical axis from an object side to an image side, wherein each of the first lens element to the fourth lens element comprises an object-side surface facing the object side and allowing imaging rays to pass through and an image-side surface facing the image side and allowing the imaging rays to pass through;
an optical axis region of the object-side surface of the first lens element is convex;
the second lens element has positive refracting power;
the third lens element has negative refracting power;
an optical axis region of the image-side surface of the fourth lens element is concave;
wherein lens elements of the optical imaging lens only comprise the first lens element to the fourth lens element, an image-side surface of a Nth lens element counted from the object side to the image side along the optical axis is cemented to an object-side surface of a N+1th lens element counted from the object side to the image side along the optical axis, and N is a positive integer greater than or equal to 1 and less than or equal to 3;
wherein the optical imaging lens satisfies: EFL/Fno≥2.200 mm, wherein EFL is an effective focal length of the optical imaging lens, and Fno is a f-number of the optical imaging lens.

8. The optical imaging lens according to claim 7, wherein the optical imaging lens satisfies the following conditional expression:
V2/V4≥1.200, wherein V2 is an Abbe number of the second lens element, and V4 is an Abbe number of the fourth lens element.

9. The optical imaging lens according to claim 7, wherein the optical imaging lens satisfies the following conditional expression:
ALT/(T2+G23+T3)≥1.600, wherein ALT is a sum of thicknesses of the first lens element through the fourth lens element along the optical axis, T2 is the thickness of the second lens element along the optical axis, G23 is a distance from the image-side surface of the second lens element to the object-side surface of the third lens element along the optical axis, and T3 is the thickness of the third lens element along the optical axis.

10. The optical imaging lens according to claim 7, wherein the optical imaging lens satisfies the following conditional expression:
EFL/(AAG+T2+G23)≥3.500, wherein AAG is a sum of a distance from the image-side surface of the first lens element to the object-side surface of the second lens element along the optical axis, a distance from the image-side surface of the second lens element to the object-side surface of the third lens element along the optical axis, and a distance from the image-side surface of the third lens element to the object-side surface of the fourth lens element along the optical axis, T2 is a thickness of the second lens element along the optical axis, and G23 is the distance from the image-side surface of the second lens element to the object-side surface of the third lens element along the optical axis.

11. The optical imaging lens according to claim 7, wherein the optical imaging lens satisfies the following conditional expression:
(TTL+AAG)/TL≥2.000, wherein TTL is a distance from the object-side surface of the first lens element to an image plane along the optical axis, AAG is a sum of a distance from the image-side surface of the first lens element to the object-side surface of the second lens element along the optical axis, a distance from the image-side surface of the second lens element to the object-side surface of the third lens element along the optical axis, and a distance from the image-side surface of the third lens element to the object-side surface of the fourth lens element along the optical axis, and TL is a distance from the object-side surface of the first lens element to the image-side surface of the fourth lens element along the optical axis.

12. The optical imaging lens according to claim 7, wherein the optical imaging lens satisfies the following conditional expression:
TTL/HFOV≥0.900 mm/°, wherein TTL is a distance from the object-side surface of the first lens element to an image plane along the optical axis, and HFOV is a half field of view of the optical imaging lens.

13. The optical imaging lens according to claim 7, wherein the optical imaging lens satisfies the following conditional expression:
BFL/(G12+T2+G23+T3+G34)≥0.800, wherein BFL is a distance from the image-side surface of the fourth lens element to an image plane along the optical axis, G12 is a distance from the image-side surface of the first lens element to the object-side surface of the second lens element along the optical axis, T2 is a thickness of the second lens element along the optical axis, G23 is a distance from the image-side surface of the second lens element to the object-side surface of the third lens element along the optical axis, T3 is a thickness of the third lens element along the optical axis, and G34 is a distance from the image-side surface of the third lens element to the object-side surface of the fourth lens element along the optical axis.

14. An optical imaging lens, comprising a first lens element, a second lens element, a third lens element, and a fourth lens element sequentially arranged along an optical axis from an object side to an image side, wherein each of the first lens element to the fourth lens element comprises an object-side surface facing the object side and allowing imaging rays to pass through and an image-side surface facing the image side and allowing the imaging rays to pass through;
the second lens element has positive refracting power;
the third lens element has negative refracting power;
an optical axis region of the object-side surface of the fourth lens element is convex; and an optical axis region of the image-side surface of the fourth lens element is concave;
wherein lens elements of the optical imaging lens only comprise the first lens element to the fourth lens element, an image-side surface of a Nth lens element counted from the object side to the image side along the optical axis is cemented to an object-side surface of a N+1th lens element counted from the object side to the image side along the optical axis, and N is a positive integer greater than or equal to 1 and less than or equal to 3;
wherein the optical imaging lens satisfies: EFL/Fno≥2.200 mm, wherein EFL is an effective focal length of the optical imaging lens, and Fno is a f-number of the optical imaging lens.

15. The optical imaging lens according to claim 14, wherein the optical imaging lens satisfies the following conditional expression:
V1/(V3+V4)≥0.790, wherein V1 is an Abbe number of the first lens element, V3 is an Abbe number of the third lens element, and V4 is an Abbe number of the fourth lens element.

16. The optical imaging lens according to claim 14, wherein the optical imaging lens satisfies the following conditional expression:
EFL/ALT≥2.500, wherein ALT is a sum of thicknesses of the first lens element through the fourth lens element along the optical axis.

17. The optical imaging lens according to claim 14, wherein the optical imaging lens satisfies the following conditional expression:
TTL·Fno/BFL≤9.000, wherein TTL is a distance from the object-side surface of the first lens element to an image plane along the optical axis, and BFL is a distance from the image-side surface of the fourth lens element to the image plane along the optical axis.

18. The optical imaging lens according to claim 14, wherein the optical imaging lens satisfies the following conditional expression:
HFOV/(AAG+T2)≤15.100°/mm, wherein HFOV is a half field of view of the optical imaging lens, AAG is a sum of a distance from the image-side surface of the first lens element to the object-side surface of the second lens element along the optical axis, a distance from the image-side surface of the second lens element to the object-side surface of the third lens element along the optical axis, and a distance from the image-side surface of the third lens element to the object-side surface of the fourth lens element along the optical axis, and T2 is a thickness of the second lens element along the optical axis.

19. The optical imaging lens according to claim 14, wherein the optical imaging lens satisfies the following conditional expression:
T1/(G23+T4)≥1.000, wherein T1 is a thickness of the first lens element along the optical axis, G23 is a distance from the image-side surface of the second lens element to the object-side surface of the third lens element along the optical axis, and T4 is a thickness of the fourth lens element along the optical axis.

20. The optical imaging lens according to claim 14, wherein the optical imaging lens satisfies the following conditional expression:
(AAG+G23)/G34≤1.500, wherein AAG is a sum of a distance from the image-side surface of the first lens element to the object-side surface of the second lens element along the optical axis, a distance from the image-side surface of the second lens element to the object-side surface of the third lens element along the optical axis, and a distance from the image-side surface of the third lens element to the object-side surface of the fourth lens element along the optical axis, G23 is the distance from the image-side surface of the second lens element to the object-side surface of the third lens element along the optical axis, and G34 is a distance from the image-side surface of the third lens element to the object-side surface of the fourth lens element along the optical axis.
